(19) United States
(12) Patent Application Publication
(10) Pub. No.: US 2015/0339708 A1
(43) Pub. Date: Nov. 26, 2015

(54) METHODS AND SYSTEMS FOR PERFORMING THIRD PARTY TRANSACTIONS

(71) Applicant: MASTERCARD INTERNATIONAL INCORPORATED, Purchase, NY (US)

(72) Inventors: Kenny Unser, Fairfield, CT (US); Kent Olof Niklas Berntsson, Rye, NY (US); Jean-Pierre Gerard, Croton On Hudson, NY (US)

(73) Assignee: MASTERCARD INTERNATIONAL INCORPORATED, Purchase, NY (US)

(21) Appl. No.: 14/718,157

(22) Filed: May 21, 2015

Related U.S. Application Data
(60) Provisional application No. 62/001,417, filed on May 21, 2014.

(51) Int. Cl. G06Q 30/02; G06Q 20/40; G06Q 20/22

(52) U.S. Cl. CPC G06Q 30/0253; G06Q 20/29; G06Q 20/40; G06Q 30/0261; G06Q 30/0269; G06Q 30/0255

(57) ABSTRACT

Methods and systems of performing multi-party transactions through a single authorization and multiple settlements is disclosed. The transaction involves a consumer entering into primary and secondary transactions as a single transaction for a merchant's and third party's products, wherein the third party products are not located at the merchant's establishment. Additionally, third party merchant offers may be filtered depending on information pertaining to the consumer.

### FIELD

The present disclosure relates generally to processing transactions and, more particularly, to computer-based methods and systems for performing multiple party transactions.

### BACKGROUND

Consumer transactions occur between two parties, a seller (or merchant) and a consumer. Typically, these transactions are limited to the merchant's product inventory, which can be composed of products produced by the merchant and products acquired by the merchant from a third party. For example, a consumer can go to a retail establishment and purchase both that establishment's goods as well as gift cards to third party establishments.

The sale of third party merchant products by a merchant involves the formation of a pre-existing relationship between the two entities. This relationship may take on one of two forms. In one form, the merchant pre-pays the third party for the products prior to the consumer's purchase. The other form involves a trust relationship where the merchant inventories the third party products but does not pay the third party for the product until after a consumer purchase of the product transpires.

These relationships can result in negative consequences for both the merchant and the third party merchant that may require extensive interactions to address, avoid or mitigate. In the former relationship, a merchant may be limited in its ability to purchase third party products due to low cash flow, resulting in decreased potential revenue of the merchant. In the latter relationship, the third party may be affected due to the merchant's business processes and data flow. As an illustration, the third party may not receive compensation in situations where, for example, the merchant decides not to pay, is unable to pay due to other debts, or the merchant files for bankruptcy. Accordingly, there is a need for a merchant to be able to sell third party products without the formation of an extensive pre-existing relationship between the merchant and the third party.

### SUMMARY

An aspect of the present disclosure pertains to providing and selecting a secondary offer, for third party products or services, to be made to a consumer while conducting a transaction to receive goods/services from a primary merchant. The present disclosure provides the consumer the ability to pay multiple parties, e.g., a merchant and one or more third party merchants, for a primary transaction and secondary transaction(s) with one payment act, such as a swipe of a payment card. The system and method disclosed facilitates the consumer interfacing for purposes of effecting a first/primary transaction with the merchant and entering into that first transaction (e.g. to get cash or a balance through an ATM). A selection occurs where an offer of a third party merchant's (i.e., a merchant without control/ownership of the establishment interfaced with by the consumer for the primary transaction) is selected for a secondary transaction relating to further goods or services to be offered to the consumer while interfacing for the primary transaction. The secondary offer provided to the consumer may be a fixed offering specific to the location of the establishment the consumer is visiting (e.g. where the primary transaction is taking place), based on a fixed predetermined contractual relationship (e.g. it may be an offer to purchase discounted goods or services at a nearby establishment proximate to the ATM), or the secondary transaction offering may occur randomly based on factors other than location (e.g. specials resulting on a particular day of the week, or time of day or other changing factors). Additionally, the secondary transaction offering may involve certain selection parameters including, for example, the consumer's purchase history, salary, payment history, credit history, outstanding balances, and available remaining line of credit of the consumer. According to aspects of the present disclosure payment is automatically provided to the multiple parties upon completion of the transaction.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a block diagram overview of an illustrative embodiment of the disclosure.

FIG. 2A is a further overview block diagram of an illustrative embodiment of the disclosure.

FIG. 2B is a block diagram detailing an illustrative embodiment of the disclosure.

FIG. 3 is a flow diagram detailing an illustrative embodiment of the disclosure.

FIG. 4 is a block diagram detailing an illustrative embodiment of the disclosure.

### DETAILED DESCRIPTION

The detailed description of aspects of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to singular embodiment may include plural embodiments, and references to more than one component may include a singular embodiment.

A consumer often may find it convenient and desirable to purchase products from multiple sources at a single location. The present disclosure relates to the consumer's ability to pay multiple parties, e.g., a merchant and one or more third party merchants, with one swipe of a payment card without the existence of an extensive, or any pre-existing relationship between the multiple parties and without the merchant ever receiving/holding funds pertaining to the purchase of third party products. This allows merchants to sell larger quantities and varieties of goods than is possible if they have to stock or pre-pay for the goods. Consequently, this disclosure gives merchants access to increased revenue streams, partnerships, and cross-marketing because they can form electronic and limited temporal customer arrangements instead of costly long-term inventory-intensive relationships.

As an illustrative implementation according to the disclosure, a customer may go to an automated teller machine (hereinafter referred to as an “ATM”). While at the ATM, an offer from a third party merchant may be displayed to the customer to get a meal at a nearby establishment at a discount, e.g., buy one get one free. While still at the ATM, the customer could accept the offer and, upon acceptance, swipe a payment card once to complete both an ATM transaction and a transaction pertaining to the offer. Upon payment, a certificate or receipt may print out at the ATM evidencing the third party merchant has already received payment and is awaiting the customer's arrival to redeem the offer. This process is not limited to an ATM but, rather, can transpire anywhere a transaction utilizing a payment card occurs. For instance, this process could occur at, for example, a gas station, a gas pump, or a car dealership. Similarly, although a payment card swipe is mentioned to effect the transaction, other mechanisms may be implemented such as debit cards, fobs, or input coding for Card-Not-Present transactions (as used herein, “payment card” should be construed to include all such devices or the like).

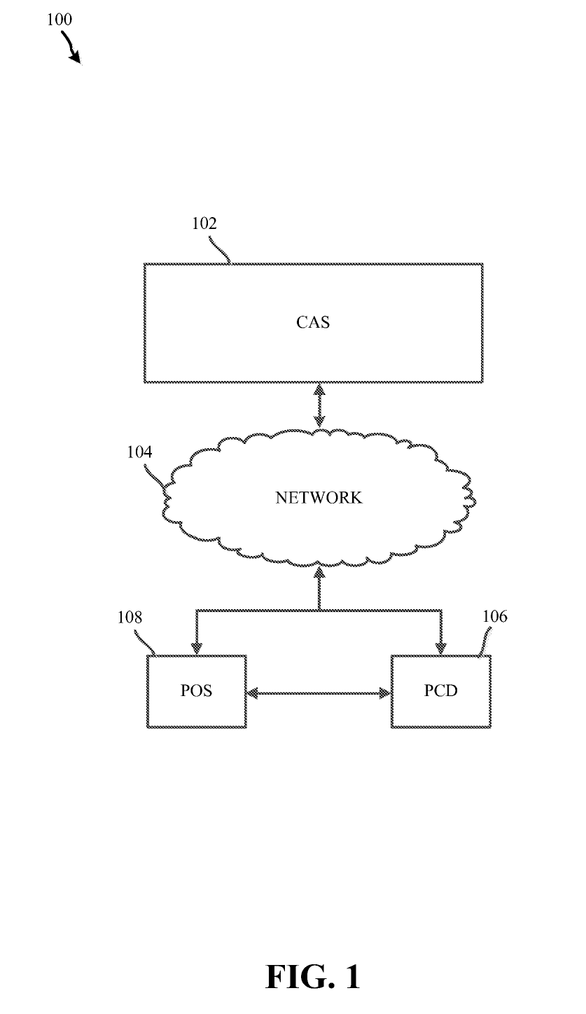

Referring to FIG. 1, a system 100 for processing payments is illustrated according to various embodiments of the disclosure. The system 100 may comprise a Card Authorization System (“CAS”) 102 for receiving transaction information and facilitating the transaction, a Network 104 for communication to/from the CAS 102, a Portable Consumer Device or Payment Card Device (“PCD”) 106 for user/customer communication to effect the transaction, and a merchant Point of Sale device (“POS”) 108 which represents the situs at which the transaction is initiated. The various system components may communicate via the Network 104 or multiple networks may be implemented and in communication.

In various embodiments, the CAS 102 (also known as an account authorization system) may be capable of or configured to perform all or part of an authorization process in relation to a payment transaction associated with a transaction account. The CAS 102 may comprise any combination of hardware and software, such as servers, databases, firewalls, computers, etc., in order to authorize transactions. In various embodiments, the CAS 102 may be operated by a payment processor (e.g., transaction account issuer).

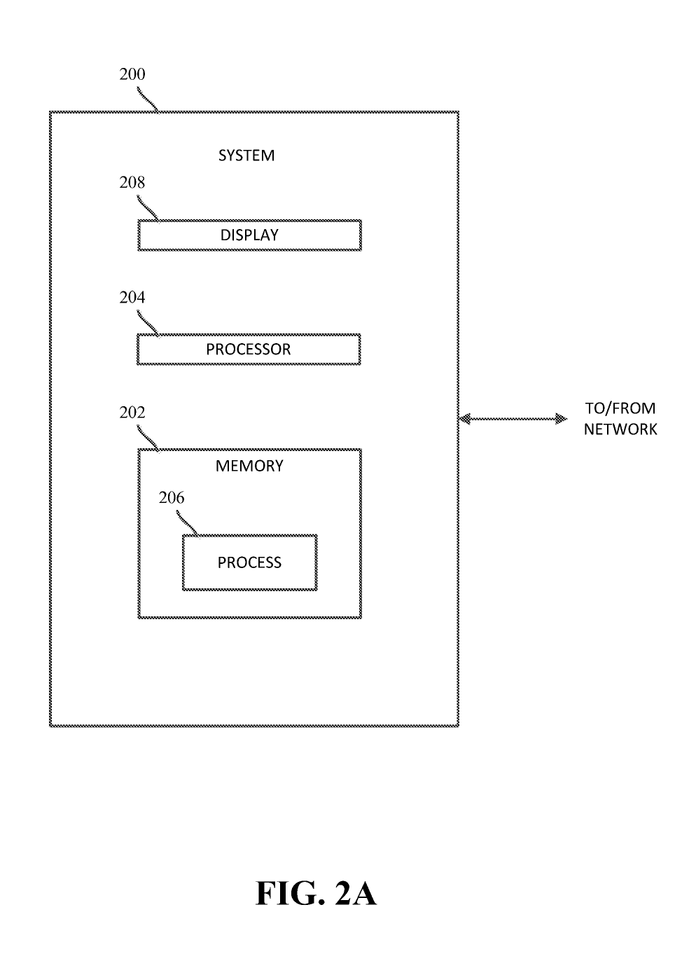

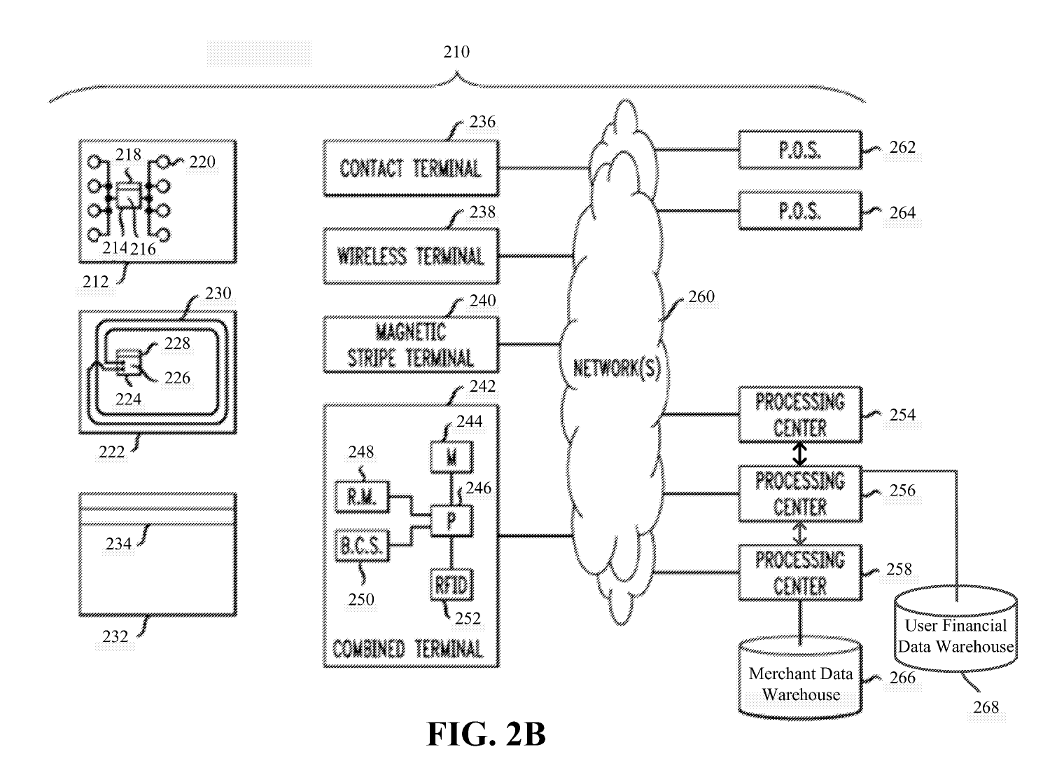

FIG. 2A is a block diagram of a system 200 that can implement part or all of one or more aspects or processes of systems within which cards according to embodiments of the present disclosure can operate or within which methods according to embodiments of the present disclosure can be carried out. As shown in FIG. 2A, a memory 202 includes instructions to configure a processor 204 to implement one or more aspects of the methods, steps, and functions disclosed herein (collectively, shown as process 206 in FIG. 2A). Different method steps may be performed by different processors. The memory 202 could be distributed or local and the processor 204 could be distributed or singular. The memory 202 could be implemented as an electrical, magnetic or optical memory, or any combination of these or other types of storage devices. It should be noted that if distributed processors are employed, each distributed processor that makes up the processor 204 generally contains its own addressable memory space. It should also be noted that some or all of the computer system 200 can be incorporated into an application-specific or general-use integrated circuit. For example, one or more method steps could be implemented in hardware in an ASIC rather than using firmware. A display 208 is representative of a variety of possible input/output devices (e.g., displays, mice, keyboards, and so on).

Attention should now be given to FIG. 2B, which depicts a non-limiting example of a system 210, within which cards according to embodiments of the present disclosure could be used, and/or within which exemplary methods according to embodiments of the present disclosure could be carried out. Various possible components of the system are shown. System 210 can include one or more different types of portable payment devices. For example, one such device can be a contact device such as a card 212. The card 212 can include an integrated circuit (IC) chip 214 having a processor portion 216 and a memory portion 218. A plurality of electrical contacts 220 can be provided for communication purposes. In addition to or instead of the card 212, the system 210 can also be designed to work with a contactless device such as a card 222. The card 222 can include an IC chip 224 having a processor portion 226 and a memory portion 228. An antenna 230 can be provided for contactless communication, such as, for example, using radio frequency (RF) electromagnetic waves. An oscillator or oscillators, and/or additional appropriate circuitry for one or more of modulation, demodulation, down conversion, and the like can be provided. Other types of devices could include a card 232 having a magnetic stripe 234, or Portable Consumer Device to input codes for CNP transactions.

The ICs 214, 224 can contain the processing units 216, 226 and the memory units 218, 228. The ICs 214, 224 can also include one or more of control logic, a timer, and input/output ports. Such elements are well known in the IC art and are not separately illustrated. One or both of the ICs 214, 224 can also include a co-processor, again, well-known and not separately illustrated. The control logic can provide, in conjunction with the processing units 216, 226, the control necessary to handle communications between the memory unit 218, 228 and the input/output ports. The timer can provide a timing reference signal from the processing units 216, 226 and the control logic. The co-processor could provide the ability to perform complex computations in real time, such as those required by cryptographic algorithms.

The memory portions or units 218, 228, and more generally all other memory discussed herein, may include different types of memory, such as volatile and non-volatile memory and read-only and programmable memory. The memory units can store transaction card data such as, e.g., a user's personal identification number (“PIN”) and/or primary account number (“PAN”). The memory portions or units 218, 228 can store the operating system of the cards 212, 222. The operating system loads and executes applications and provides file management or other basic card services to the applications. One operating system that can be used is the MULTOS® operating system licensed by MAOSCO Limited. (MAOSCO Limited. St.

Andrews House, The Links, Kelvin Close, Birchwood, Warrington, WA3 7PB. United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within the memory portion 218, 228. Flash memory or other non-volatile and/or volatile types of memory may also be used in the memory units 218, 228.

In addition to the basic services provided by the operating system, the memory portions 218, 228 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that, strictly speaking, the EMV specification defines the behavior of a terminal; however, the card can be configured to conform to such EMV-compliant terminal behavior and in this sense is itself EMV-compliant. It will be appreciated that applications can be configured in a variety of different ways.

As noted, the cards 212, 222 are examples of a variety of payment devices. Devices could include cards having a conventional form factor, smaller or larger cards, cards of different shape, key fobs, and the like. The cards can include body portions (e.g., laminated plastic layers of a payment card, chip packaging, and the like), the memories 218, 228 associated with the body portions, and the processors 216, 226 associated with the body portions and coupled to the memories. The memories 218, 228 can contain appropriate applications. The processors 216, 226 can be operative to execute one or more method steps. The applications can be, for example, application identifiers (AIDs) linked to software code in the form of firmware plus data in a card memory such as an electrically erasable programmable read-only memory (EEPROM). Again, note that “smart” cards are not necessarily required and a conventional magnetic stripe card can be employed.

Note that it is presently prevalent to employ full-sized cards of a conventional form factor in order to have sufficient space to include the acceptance attributes on a single side. Cards may conform to the ISO/IEC 7810 ID-1 format for example (also referred to as “full sized” or “conventional form factor”).

A number of different types of terminals can be employed with system 210. Such terminals can include a contact terminal 236 configured to interface with the contact-type device 212, a wireless terminal 238 configured to interface with wireless device 222, a magnetic stripe terminal 240 configured to interface with a magnetic stripe device 232, or a combined terminal 242. The combined terminal 242 is designed to interface with any type of device 212, 222, 232. Some terminals can be contact terminals with plug-in contactless readers. The combined terminal 242 can include a memory 244, a processor portion 246, a reader module 248, and optionally an item interface module such as a bar code scanner 250 and/or a radio frequency identification (RFID) tag reader 252. Items 244, 248, 250, 252 can be coupled to the processor 246. Note that the principles of construction of the combined terminal 242 are applicable to other types of terminals and are described in detail for illustrative purposes. The reader module 248 can be configured for contact communication with card or device 212, contactless communication with card or device 222, reading of magnetic stripe 234, or a combination of any two or more of the foregoing (different types of readers can be provided to interact with different types of cards e.g., contacted, magnetic stripe, or contactless). The terminals 236, 238, 240, 242 can be connected to one or more processing centers 254, 256, 258 via a computer network 260. The network 260 could include, for example, the Internet, or a proprietary network. More than one network could be employed to connect different elements of the system. The processing centers 254, 256, 258 can include, for example, a host computer of an issuer of a payment device.

Many different retail or other establishments, represented by the points-of-sale 262, 264, can be connected to the network 260. In one or more instances, various establishments may interface with a telecommunications network, such as a virtual private network (VPN), via one or more machines which are then connected to the network. Each such establishment can have one or more terminals. Further, different types of portable payment devices, terminals, or other elements or components can combine or “mix and match” one or more features depicted on the exemplary devices in FIG. 2B

Portable payment devices can facilitate transactions by a user with a terminal, such as the contact terminal 236, wireless terminal 238, magnetic stripe terminal 240, and combined terminal 242, of a system such as the system 210. Such a device can include a processor, for example, the processing units 216, 226 discussed above. The device can also include a memory, such as the memory portions 218, 228 discussed above, that is coupled to the processor. Further, the device can include a communications module that is coupled to the processor and configured to interface with a terminal such as one of the contact, wireless, magnetic strip, and combined terminals 236, 238, 240, 242. The communications module can include, for example, the contacts 220 or antennas 230 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

It will be appreciated that the contact, wireless, magnetic stripe, and combined terminals 236, 238, 240, 242 are examples of terminal apparatuses for interacting with a payment device of a holder. The apparatus can include a processor such as processor 246, a memory such as memory 244 that is coupled to the processor 246, and a communications module such as the reader module 248 that is coupled to the processor 246 and configured to interface with the portable apparatuses. The processor 246 can be operable to communicate with portable payment devices of a user via the communications module 248. The terminal apparatuses can function via hardware techniques in the processor 246, or by program instructions stored in the memory 244. Such logic could optionally be provided from a central location such as the processing center 254 over the network 260. The aforementioned bar code scanner 250 and/or RFID tag reader 252 can be provided, and can be coupled to the processor 246, to gather attribute data, such as a product identification, from a UPC code or RFID tag on a product to be purchased.

The above-described devices 212, 222 can be ISO 7816-compliant contact cards or devices or NFC (Near Field Communications) or ISO 14443-compliant proximity cards or devices. In operation, card 222 can be touched or tapped on the wireless or combined terminal 238 or 242, which then contactlessly transmits the electronic data to the proximity IC chip in the card 222 or other wireless device.

One or more of the processing centers 254, 256, 258 can include a database such as a merchant data warehouse 266 or user financial data warehouse 268. The merchant data warehouse 266 may contain information regarding, for example, product(s), offer(s), pricing, and timing. The user financial data warehouse 268 may include information pertaining to a card holder, such as salary, payment history, credit history, outstanding balances, and available remaining line of credit on the card holder's card. The processing centers 254, 256, 258 may be operably connected in order to share information. For example, the processing centers 256, 258 may be connected to allow the interchange of information contained within the warehouses 266, 268. This exchange of information may result in the selection/exclusion of certain offers contained within the merchant data warehouse 266 being or not being offered to the card holder based on the information contained within one of the merchant data warehouse or the user financial data warehouse 268.

Cards in accordance with embodiments of the present disclosure may be used within larger systems that can employ hardware and/or software aspects. Software includes but is not limited to firmware, resident software, microcode, etc. Software might be employed, for example, in connection with a terminal 236, 238, 240, 242; a processing center 254, 256, 258 (optionally with data warehouses 266, 268) of a merchant, issuer, acquirer, processor, or operator of a network operating according to a payment system standard (and/or specification); and the like. Firmware might be employed, for example, in connection with payment devices such as cards 212, 222.

Thus, elements of a system can make use of computer technology with appropriate instructions to facilitate method steps. By way of further example, a terminal apparatus 236, 238, 240, 242 could include, inter alia, a communications module, an antenna coupled to the communications module, a memory, and at least one processor coupled to the memory and the communications module and operative to integrate a contactless payment device (in lieu of the antenna and communications module, appropriate contacts and other elements could be provided to interrogate a contact payment device such as a contact card or read a magnetic stripe).

As used herein, the term “end user”, “consumer”, “customer”, “card member” may be used interchangeably herein, and likewise “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure.

An electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

Each participant may be equipped with a computing device in order to interact with the system and facilitate online commerce transactions. The customer may have a computing unit in the form of a personal computer, although other types of computing units may be used including laptops, notebooks, hand held computers, set-top boxes, cellular telephones, touch-tone telephones and the like. The merchant may have a computing unit implemented in the form of a computer-server, although other implementations are contemplated by the system. The bank may have a computing center shown as a main frame computer. However, the bank computing center may be implemented in other forms, such as a mini-computer, a PC server, a network of computers located in the same or different geographic locations, or the like. Moreover, electronic commerce systems as described herein may facilitate the use, sale or distribution of any goods, services or information over any network having similar functionality described herein.

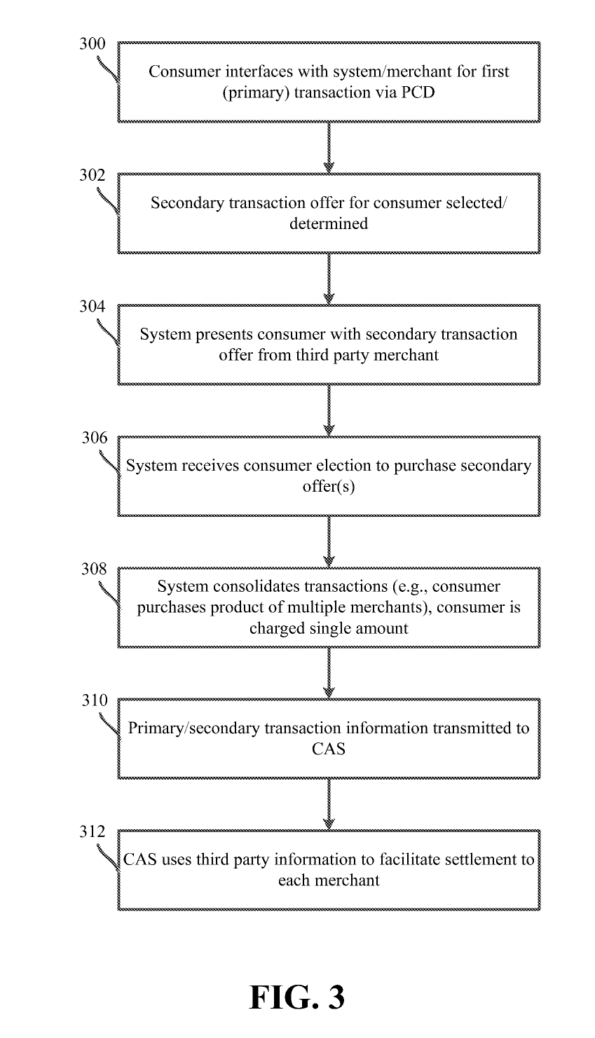

Referring to FIG. 3, a method according to an illustrative embodiment of the disclosure is described. In an interfacing step 300, a consumer interfaces with a merchant institution, for example, a physical or virtual store, ATM, kiosk, or any other merchant establishment. Upon the consumer interfacing for purposes of effecting a first transaction with the merchant entering into that first transaction (e.g. to get cash or a balance through an ATM), a selection step 302 occurs where an offer of a third party merchant's (i.e., a merchant without control/ownership of the establishment interfaced with in the interfacing step 300), a secondary transaction relating to further goods or services to be offered to the consumer is selected by the automated system or otherwise determined for offering to the consumer. This selection may be a fixed offering specific to the location of the establishment the consumer is visiting, based on a fixed predetermined contractual relationship (e.g. it may be an offer to purchase discounted goods or services at a nearby establishment proximate to the ATM), or the secondary transaction offering may occur randomly based on factors other than location (e.g. specials resulting on a particular day of the week, or time of day or other changing factors). Additionally, the secondary transaction offering may involve certain selection parameters including, for example, the consumer's purchase history, salary, payment history, credit history, outstanding balances, and available remaining line of credit on the consumer's Portable Consumer Device (“PCD”). Upon the secondary transaction offer being determined, a presenting step 304 occurs where the consumer is presented with one or more of the selected secondary transaction offers from the third party merchant. For example, while at an ATM, the consumer may be prompted to accept an offer for a discounted lunch at a nearby restaurant, or while at a car dealership, the consumer may be offered third party automobile accessories, which are not held in stock by the car dealership. As a further example, while at a merchant, the consumer may be offered a third party warrantee or service plan on goods or services of the merchant.

The offer(s) presented to the consumer in the presenting step 304 may originate at any time appropriate to generate a relevant offer to the consumer. In one embodiment, model scoring may be used to determine the appropriate offers to be presented to a consumer. In another embodiment, an offers marketplace may be used that matches third party offers with certain merchants and/or consumers. In a further embodiment, pricing information may be used to determine what offer to present to a consumer. Such pricing information may include, for example, item cost, item availability, tax pricing, commission arrangement, interchange information, or any other information that may affect the pricing of the offer to be provided in the secondary transaction. In yet another embodiment, the offer may be generated and delivered some time during the transaction, for example, post-authorization. This secondary offer may be generated according to a designated triggering event, such as a purchase. Additionally, the triggering event or purchase may impose certain qualification criteria such as, for example, a minor consumer (i.e., below the age of 18 years old) should not receive an offer relating to alcohol or tobacco products or services. As an illustrative example of this last embodiment, an ATM transaction may trigger a secondary transaction offer to dine at a local restaurant. In another example, the purchase of an automobile may trigger a secondary offer for a rooftop cargo box compatible with the vehicle's luggage rack system available from a third party merchant. In an even further example, the determination that the consumer is a parent of a young child may trigger a secondary transaction offer for child care services.

Following the presenting step 304, an election step 306 may occur where the system receives an indication that the consumer elects to purchase one or more items contained in the one or more secondary offers of the presenting step 304. In a purchasing step 308, after the system receives an indication that the consumer accepted the secondary offer(s), the system may consolidate the transactions (primary and secondary) so that the consumer is charged a single, sum total amount for all the goods or services purchased from the merchant establishment in the primary transaction and the secondary transaction from the third party merchant offer(s). This single amount is transacted using a single authorization of the consumer's PCD (e.g., single swipe of the consumer's payment card). During the purchasing step 308, a point-of-sale (POS) terminal may collect information pertaining to the purchase, and relating to the consolidated transactions. Such purchase information may include, for example, the identity of the merchants, the prices of the goods or services being purchased, the tax collected, a commission to be paid to the visited merchant, delivery information, interchange rate data specific to each merchant, as well as any other information that may identify the purchases/transactions. For example, the commission may result in the primary transaction merchant receiving a 5% or 10% commission from secondary transaction third party goods or services purchased. Regarding the delivery information, as an illustrative example, a car dealership may provide the consumer with an offer to purchase accessories at the time of an auto purchase but instead of the dealer having the accessories stocked, the accessories may be shipped directly to the consumer at an address other than the dealership.

In a transmitting step 310, a POS terminal interfaced to the system or a payments processing software module transmits the purchase information collected during the purchasing step 308 to a Card Authorization System (also known as an account authorization system, associated with the consumer's card, for authorization and clearing, or a “CAS”). After the transmitting step 310 occurs, an authorization step 312 transpires where the CAS utilizes the information received for the single transaction to facilitate settlement to each of the merchants whose goods or services were purchased in the primary and secondary transactions.

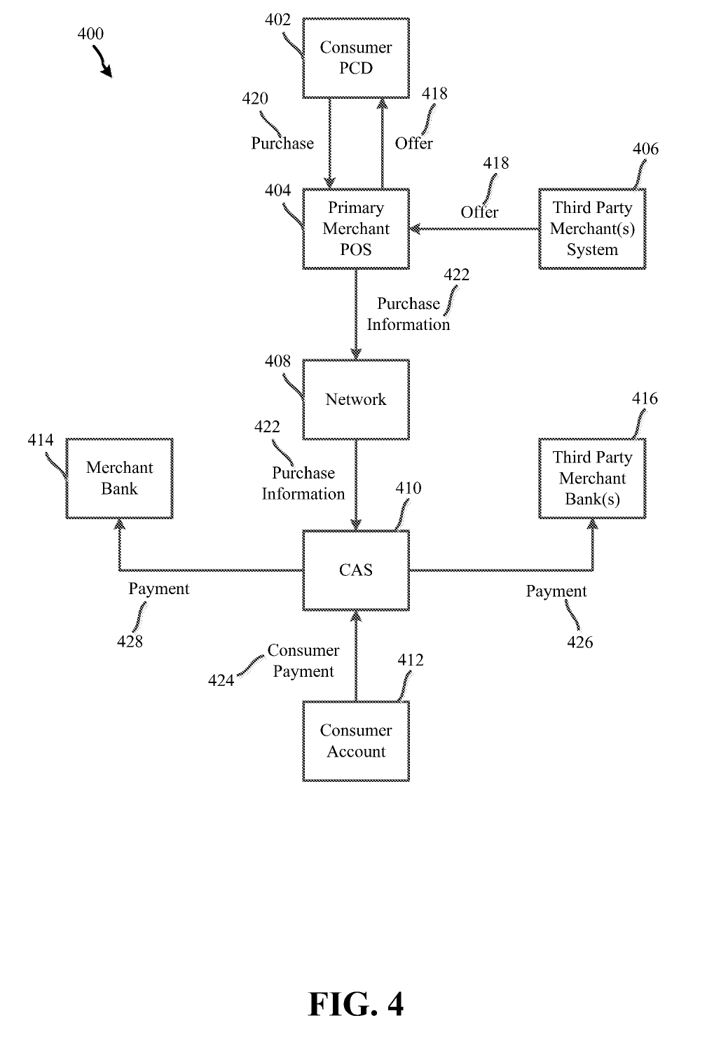

Referring now to FIG. 4, the system 400 according to the present disclosure is described. A consumer via a PCD 402 accesses a merchant establishment 404, such as via a POS terminal 404 as described hereinbefore, and is presented with one or more third party merchant(s) 406 offers 418 (e.g. secondary offer(s) as described). The merchant may have the ability to filter or set parameters to control what offers each consumer receives, without the merchant ever knowing the content of the secondary offer(s) 418. For example, a targeting filter may be applied to only convey secondary offers 418 that are relevant to the consumer 402, such as, secondary only offers 418 from originating within a geographic range of the primary merchant's establishment or secondary offers 418 relating to the types of primary merchant goods or services being purchased. Additionally, the primary merchant may set parameters that require, for example, the offers 418 be selected randomly, the offers 418 not be from a competitor, or the offers 418 not pertain to something that will offend the merchant's customers.

Separately or in conjunction with the merchant imposed filters, the consumer may also need to satisfy other certain parameters in order to receive certain offer(s) 418. For example, the offer(s) 418 selected for presentment to the consumer may be limited according to information available on the user from a financial data warehouse (268, FIG. 2B), such as the consumer's salary, payment history, credit history, outstanding balances, and available remaining line of credit on the consumer's Portable Consumer Device (“PCD”). The consumer transacts a single purchase 420 containing primary merchant and third party merchant(s) 406 goods or services with a single authorization of the consumer's PCD at the point-of-sale (POS) terminal 404. The POS terminal 404 collects purchase information 422 and conveys it through a network 408 to a Card Authorization System (also known as an account authorization system, associated with the consumer's PCD, for authorization and clearing, or a “CAS”), 410. This purchase information 422 may include, for example, the identity of the primary merchant and third party merchant(s), the prices of the goods or services being purchased, the tax collected, the commission to be paid to the primary merchant, delivery information, interchange rate data specific to each merchant, or any other information that may identify the purchase. The CAS 410, using the purchase information 422, conducts a single authorization for the payment, but may facilitate several settlements of the single payment with respect to the primary merchant and each individual third party merchant whose goods or services were purchased via the consumer PCD 402.

During this settlement process, the CAS 410 receives a consumer payment 424, from the consumer's account 412 related to the consumer's PCD 402. The consumer payment 424 is sufficient to settle every individual transaction regarding the merchant and each third party merchant 406 involved in the single purchase 420. The CAS 410 then disburses a payment 426, respective of each third party merchant 406 or secondary transaction, to their respective third party merchant bank 416. Simultaneously, the CAS 410 also transmits a payment 428 to the merchant's bank 414. This payment 428 may include the total cost of the primary merchant's purchased goods or services as well as a commission from the sale of the third party merchant(s) 406 goods or services. Such commission may be deducted from the total cost of the third party merchant(s) 406 purchased goods or services, resulting in the payment 426 made to the third party merchant bank 416 being less than the actual price of the purchased third party merchant 406 good or service.

As is known in the art, it should be appreciated that part or all of one or more aspects of methods and apparatuses described may be distributed as an article of manufacture that itself comprises a computer readable medium having computer readable code means embodied thereon. The computer readable program code means is operable, in conjunction with a computer system, to carry out all or some of the steps to perform the methods or create the apparatuses described. A computer usable medium may be a tangible computer-readable recordable storage medium e.g., floppy disks, hard drives, compact disks, EEPROMs, or memory cards; not including a transmission medium or disembodied signal) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement methods, steps, and functions. Such methods, steps, and functions can be carried out, e.g., by processing capability on various system elements or by any combination of elements. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more aspects of a system can include a computer program comprising computer program code means adapted to perform one or more steps when such program is run on a computer, and that such program may be embodied on a tangible computer readable recordable storage medium; for example, in the form of distinct software modules which then execute on one or more hardware processors. Further, a system can include a computer comprising code adapted to cause the computer to carry out one or more steps, together with one or more apparatus elements or features.

Computers discussed herein can be interconnected, for example, by one or more of network, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the logic described.

As described herein a network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system.

Various embodiments are directed toward one or more computer systems capable of carrying out the functionality described herein.

After reading this description, it will become apparent to a person skilled in the relevant art(s) how to implement various embodiments using other computer systems and/or architectures. Computer systems can include a display interface that forwards graphics, text, and other data from the communication infrastructure (or from a frame buffer not shown) for display on a display unit. Computer system also includes a main memory, such as for example random access memory (RAM), and may also include a secondary memory and or a removable storage unit. As will be appreciated, the removable storage unit includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

Computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Databases or data warehouses discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, AJAX, WSDL and UDDI, Web services methods are well known in the art, and are covered in many standard texts.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A system for performing a transaction, comprising:
a transaction terminal configured to access at least one of a merchant data database and a financial data database during a user transaction;
a selecting authority in communication with the transaction terminal, the selecting authority including a memory and a processor, the processor configured to offer a consumer a primary transaction and select a secondary transaction offer about a secondary transaction to be presented to the consumer;
an authorizing authority in communication with the transaction terminal and the selecting authority, the authorizing authority including a processor configured to perform the following:
receive from the transaction terminal information about the primary transaction involving a merchant and receive information from the transaction terminal about the secondary transaction involving a third party merchant;
authorize the primary transaction and the secondary transaction using the information from the transaction terminal; and
automatically transfer payment to both the merchant and the third party merchant upon completion of the user transaction.

2. The system of claim 1, further comprising a third party merchant apparatus in communication with the selecting authority, the third party merchant apparatus including offer information specific to at least one third party merchant product or service.

3. The system of claim 1, wherein the selecting authority selects the secondary transaction offer using a location of the transaction terminal.

4. The system of claim 1, wherein the selecting authority selects the secondary transaction offer using consumer specific information.

5. The system of claim 4, wherein the consumer specific information includes at least one of purchase history, salary, or credit history.

6. The system of claim 1, wherein the secondary transaction offer is for a warrantee on at least one third party merchant product or service.

7. An apparatus for performing primary and secondary transactions, comprising:
a memory;
at least one processor operatively coupled to the memory; and
a persistent storage device operatively coupled to the memory and storing in a non-transitory manner instructions that when loaded into the memory cause the at least one processor to:
receive a request for authorization of a primary transaction involving a merchant and a consumer from a transaction terminal;
transmit a secondary transaction offer involving a third party merchant to the transaction terminal for presentment to the consumer; and
receive a response from the transaction terminal evidencing whether the consumer intends to enter into a secondary transaction.

8. The apparatus of claim 7, wherein the processor transmits an authorization request to an authorizing authority, the authorizing authority being configured to disperse funds from an account affiliated with the consumer.

9. The apparatus of claim 8, wherein the authorization request includes information specific to the primary transaction and the secondary transaction.

10. The apparatus of claim 8, wherein the authorizing authority transfers payment for the primary transaction to the merchant and transfers payment for the secondary transaction to the third party merchant.

11. The apparatus of claim 7, wherein the secondary transaction offer is obtained from a third party merchant database.

12. The apparatus of claim 7, wherein the secondary transaction offer includes information specific to at least one third party merchant product or service.

13. The apparatus of claim 7, wherein the processor selects the secondary transaction offer according to temporal considerations.

14. The apparatus of claim 7, wherein the processor selects the secondary transaction offer using pricing information.

15. The apparatus of claim 14, wherein the pricing information includes at least one of item cost, item availability, and tax pricing.

16. The apparatus of claim 7, wherein the processor selects the secondary transaction offer using an age of the consumer.

17. A method for performing primary and secondary transactions, comprising the steps of:
receiving an authorization request for a primary transaction involving a merchant and a consumer from a transaction terminal;
selecting a secondary transaction offer from a third party merchant database;
transmitting the secondary transaction offer specific to a third party merchant to the transaction terminal for presentment to the consumer;
receiving an election from the transaction terminal evidencing whether the consumer intends to enter into a secondary transaction; and
transmitting an authorization request to an authorizing authority, the authorization request being specific to the primary transaction when the election indicates the consumer wants to perform only the primary transaction, and the authorization request being specific to the primary transaction and secondary transaction when the election indicates the consumer wants to perform both the primary transaction and the secondary transaction.

18. The method of claim 17, wherein the secondary transaction offer is selected using location information specific to the transaction terminal.

19. The method of claim 17, wherein the secondary transaction offer is selected using at least one product or service involved in the primary transaction.

20. The method of claim 17, wherein the secondary transaction offer is selected using at least one of portable consumer device information or pricing information.
